(19) United States
(12) Patent Application Publication
(10) Pub. No.: US 2008/0227595 A1
(43) Pub. Date: Sep. 18, 2008

(54) Hydraulic system for controlling a belt-driven conical-pulley transmission

(75) Inventors: Jochen Pfister, Strasbourg (FR); Roshan Willeke, Karlsruhe (DE); Eric Muller, Kaiserslautern (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/072,138

(22) Filed: Feb. 21, 2008

Related U.S. Application Data
(60) Provisional application No. 60/902,561, filed on Feb. 21, 2007.
(60) Provisional application No. 60/902,562, filed on Feb. 21, 2007.
(60) Provisional application No. 60/902,563, filed on Feb. 21, 2007.
(60) Provisional application No. 60/919,398, filed on Mar. 22, 2007.
(60) Provisional application No. 60/937,273, filed on Jun. 26, 2007.
(60) Provisional application No. 60/937,274, filed on Jun. 26, 2007.
(60) Provisional application No. 60/937,275, filed on Jun. 26, 2007.
(60) Provisional application No. 60/937,276, filed on Jun. 26, 2007.

(51) Int. Cl. F16H 61/662

(52) U.S. Cl. 477/48

(57) ABSTRACT

A hydraulic system for controlling a belt-driven conical-pulley transmission of a motor vehicle having a variably adjustable transmission ratio, and having an electrical actuation system for overall control of the hydraulic system, and a hydraulic parking lock-release system to control a parking lock. In order to provide an improved hydraulic system, the parking lock includes a self-retention system in the event of an electrical power failure.

### BACKGROUND OF THE INVENTION

1. Field of the Invention

The present invention relates to a hydraulic system for controlling a belt-driven conical-pulley transmission (CVT) with a variably adjustable transmission ratio, of a motor vehicle, having an electrical actuation system for overall control of the hydraulic system and a hydraulic parking lock-release system to control a parking lock. The present invention also relates to a belt-driven conical-pulley transmission controlled thereby and to a motor vehicle equipped therewith.

2. Description of the Related Art

Belt-driven conical-pulley transmissions can have a continuously variable transmission ratio, in particular automatically effected transmission ratio variation.

Such continuously variable automatic transmissions have for example a drive-off unit, a reversing planetary gearbox as the forward/reverse drive unit, a hydraulic pump, a variator, an intermediate shaft and a differential. The variator comprises two pairs of conical disks and an encircling element. Each conical disk pair includes a second conical disk that is movable in the axial direction. Between these pairs of conical disks runs the encircling element, for example a steel thrust belt, a tension chain or a drive belt. Moving the second conical disk changes the running radius of the encircling element, and thus the transmission ratio of the continuously variable automatic transmission.

Continuously variable automatic transmissions require a high level of pressure in order to be able to move the conical disks of the variator with the desired speed at all operating points, and also to transmit the torque with sufficient basic pressure with minimum wear. The overall control can be effected by means of an electrical actuation system, which can have for example electrically operated proportional valves.

An object of the present invention is to provide a hydraulic system of a belt-driven conical-pulley transmission and/or a belt-driven conical-pulley transmission that behaves as robustly as possible in the event of an electric power failure of a provided electrical actuation system, and that especially prevents an unwanted engagement of an existing parking lock when a power outage occurs, or at least only permits it after a time delay.

### SUMMARY OF THE INVENTION

The object is achieved with a hydraulic system of a motor vehicle for controlling a belt-driven conical-pulley transmission (CVT) having a variably adjustable transmission ratio, having an electrical actuation system for overall control of the hydraulic system and a hydraulic parking lock-release system to control a parking lock, by allowing the parking lock to have self-retention when there is a power outage of the electrical actuation system. Advantageously, in comparison to conventional hydraulic concepts for shift-by-wire, by means of the provided self-retention the parking lock can remain in the non-engaged state even in the event of an electric power failure, at least for a certain time. Advantageously, in the event of an electric power failure in an associated transmission control, the self-retention system can hold the parking lock in the non-engaged state for 500 ms or longer. Advantageously, that can be exploited for a reset of the transmission control, which is accompanied for example by a complete outage of the transmission control, i.e., a powering down of all associated control valves for approximately 500 ms. In comparison to conventional hydraulic concepts, a falling back of a corresponding parking lock piston combined with an engagement of the parking lock, for example already after 50 ms, can be reliably avoided due to the provided self-retention. That enables the occurrence of chattering of the parking lock when traveling at high speed, or immediate engagement at a speed below 3 km/h to be reliably avoided, even in the case of electric power failure or a reset of the trans-mission control.

A preferred exemplary embodiment of the hydraulic system is characterized in that the hydraulic parking lock-release system includes a valve, in particular a second valve, for hydraulic actuation of a parking lock cylinder positioned downstream from the second, for mechanical actuation of the parking lock. The necessary hydraulic pressure for operating the parking lock can be fed to the parking lock cylinder by means of the valve.

Another preferred exemplary embodiment of the hydraulic system is characterized in that the electrical actuation system includes in particular a fourth valve positioned upstream from the second valve to actuate in particular a second control piston of the in particular second valve. The in particular fourth valve can be for example an electrically actuated proportional valve, which in the event of an electric power failure switches the control pressure for the in particular second valve to the tank. Depending on the actuation state of the in particular fourth valve, the latter can provide a pilot pressure for the in particular second control piston of the in particular second valve.

Another preferred exemplary embodiment of the hydraulic system is characterized in that the parking lock cylinder includes a first sub-cylinder and a second sub-cylinder. Advantageously, two control pressures can be processed through the two sub-cylinders. Advantageously, a second control pressure for the second sub-cylinder can serve to realize the self-retention.

Another preferred exemplary embodiment of the hydraulic system is characterized in that to realize the self-retention, with the parking lock disengaged the second cylinder is connected downstream to an in particular seventh valve of an in particular second valve arrangement to control the transmission ratio of the belt-driven conical-pulley transmission. Advantageously, the in particular seventh valve, located upstream, can apply a second control pressure to the in particular second sub-cylinder. Advantageously, that second control pressure can remain intact even during the power outage, so that advantageously the parking lock can remain in self-retention.

Another preferred exemplary embodiment of the hydraulic system is characterized in that the in particular second sub-cylinder is connected to a first port of the seventh valve. The second control pressure can be controlled through the first port to realize the self-retention. Advantageously, the in particular seventh valve can be connected so that it applies pressure to the first port during the electric power outage.

Another preferred exemplary embodiment of the hydraulic system is characterized in that the electric actuation system includes an in particular eighth valve to actuate the in particular seventh valve, which switches the first port of the in particular seventh valve to a system pressure of the hydraulic system during the power outage. Advantageously, during the power outage the first port of the in particular seventh valve is connected to the system pressure. To that end the in particular eighth valve can be actuated electrically accordingly, so that during the power outage it automatically provides an appropriate control pressure for the in particular seventh valve, so that the latter connects the first port to the system pressure.

Another preferred exemplary embodiment of the hydraulic system is characterized in that the in particular second valve actuates the first sub-cylinder downstream. Through the first sub-cylinder, the parking lock can be optionally engaged and disengaged by means of the activation of the in particular second valve.

Another preferred exemplary embodiment of the hydraulic system is characterized in that the first and the second sub-cylinder are positioned one after the other. Advantageously, that can result in series connection of the sub-cylinders, so that applying a control pressure to the first sub-cylinder by a mechanical coupling, i.e., by impacting the first sub-cylinder against the second sub-cylinder, which is mechanically coupled to the parking lock, can accordingly bring about a disengagement of the parking lock. In the event of self-retention, the first sub-cylinder can accordingly fall back from the no longer present control pressure of the in particular second valve, i.e. separate itself from the second sub-cylinder. In that case the second sub-cylinder alone takes over the self-retention of the parking lock, as long as it is subjected to the system pressure by means of the in particular seventh valve. Advantageously therefore, by means of the arrangement one behind the other, the first and the second sub-cylinder can be OR-linked, it being sufficient that the first or the second cylinder is subjected to a system pressure for the parking lock to remain disengaged.

Another preferred exemplary embodiment of the hydraulic system is characterized in that the in particular second valve actuates the first and second sub-cylinders. Alternatively, it is possible for the control pressure of the in particular second valve to actuate the first and the second sub-cylinders, these being connected in parallel with regard to the control pressure of the in particular second valve.

Another preferred exemplary embodiment of the hydraulic system is characterized in that the first sub-cylinder is positioned in a first bore of the second sub-cylinder. It is possible by means of the nested arrangement to realize parallel connection, while in addition the already described series connection or OR-linkage of the first and second sub-cylinders results.

Another preferred exemplary embodiment of the second cylinder is characterized in that during the power outage the second cylinder is connected to the in particular seventh valve, and through an orifice plate to a tank. Advantageously, the second sub-cylinder can be connected by means of the in particular seventh valve to the system pressure, and simultaneously through the orifice plate to the tank. The pressure that builds up can be used to hold the parking lock in its engaged state. In that respect the second sub-cylinder is OR-linked with the first sub-cylinder with regard to the pressures of the in particular second valve and the in particular seventh valve. In addition, the first and the second sub-cylinder are connected in parallel with regard to the control pressure of the in particular second valve.

Another preferred exemplary embodiment of the hydraulic system is characterized in that in the event of power failure with the parking lock engaged the first sub-cylinder assigns the second sub-cylinder to the tank, and it blocks the assignment of the second sub-cylinder to the first port when the parking lock is engaged by means of the electrical actuation system. Advantageously, by means of the AND-linkage of the first sub-cylinder and the second sub-cylinder, with control pressure applied, of the in particular second valve can move into the bore of the second sub-cylinder. Advantageously, the assignment to the in particular seventh valve and the tank can be accomplished by means of perforations of the second sub-cylinder, whereby the control pressures are passed into an interior of the bore of the second sub-cylinder. Advantageously, when the first control pressure of the second valve is applied, the first sub-cylinder can be pressed into the bore of the second sub-cylinder in such a way that the first sub-cylinder blocks the perforations made in a wall of the second sub-cylinder to the tank. Advantageously, provision can be made here so that the perforation to the in particular seventh valve is not blocked, or is only partially blocked, with the control pressure advantageously supplied by means of the in particular seventh valve present on the end of the first cylinder facing into the bore, so that that cylinder automatically retracts when no control pressure is present from the second valve, i.e. it can release the connection to the tank through the orifice plate. It can be ensured by way of the orifice plate that when the hydraulic system is totally shut down the control pressure for the self-retention of the parking lock is released spontaneously after a period of time that can be set by means of the dimensioning of the orifice plate, so that in that case the parking lock can be engaged automatically.

The object is also achieved with a belt-driven conical-pulley transmission having a hydraulic system of the type described above.

The object is also achieved with a motor vehicle having a belt-driven conical-pulley transmission of the type described above.

### BRIEF DESCRIPTION OF THE DRAWINGS

The structure, operation, and advantages of the present invention will become further apparent upon consideration of the following description taken in conjunction with the accompanying drawings, in which:

FIG. 1 is a hydraulic circuit diagram of a hydraulic system for controlling a belt-driven conical-pulley transmission;

FIG. 2 is a detail of the hydraulic system shown in FIG. 1, with a bipartite parking lock cylinder;

FIG. 3 shows the bipartite parking lock cylinder shown in FIG. 2, with the parking lock engaged;

FIG. 4 shows the parking lock cylinder shown in FIG. 3, with the parking lock not engaged or actuated, i.e., with the parking lock cylinder connected;

FIG. 5 shows the parking lock cylinder shown in FIGS. 3 and 4 in a switch state that corresponds to an electric power outage, with the parking lock in hydraulic self-retention;

FIG. 6 shows another exemplary embodiment of a bipartite parking lock cylinder, with the parking lock engaged;

FIG. 7 shows the bipartite parking lock cylinder shown in FIG. 6, with the parking lock not engaged; and

FIG. 8 shows the parking lock cylinder shown in FIGS. 6 and 7, with the switch state corresponding to an electric power outage, and with the parking lock in self-retention.

### DESCRIPTION OF THE PREFERRED EMBODIMENTS

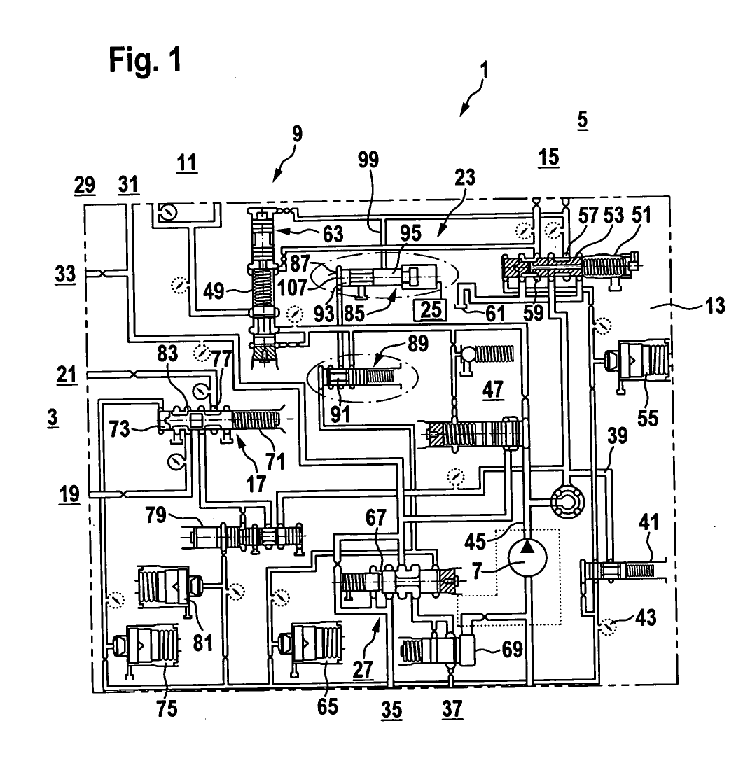

FIG. 1 shows a portion of a circuit diagram of a hydraulic system 1. Hydraulic system 1 is used to control a belt-driven conical-pulley transmission, which is indicated with the reference numeral 3 in FIG. 1. Belt-driven conical-pulley trans-mission 3 can be part of a power train of a motor vehicle 5, which is indicated by reference numeral 5. Hydraulic system 1 includes a hydraulic energy source 7, for example a mechanically or electrically driven hydraulic pump to transport a hydraulic medium. For propulsion, the hydraulic energy source 7 can be connected to a combustion engine (not shown in greater detail) of the motor vehicle 5. Hydraulic energy source 7 serves to supply hydraulic system 1 with hydraulic energy.

Connected downstream from hydraulic energy source 7 is a first valve arrangement 9, which is connected to a torque sensor 11. First valve arrangement 9 and torque sensor 11 serve to provide and/or control a clamping pressure to transfer torques between conical disks and a corresponding encircling element of belt-driven conical-pulley transmission 3, in particular depending on the torques present at belt-driven conical-pulley transmission 3. Downstream, torque sensor 11 is connected through a cooler (not shown) to a cooler return 31. Torque sensor 11 can raise or lower a system pressure 45 delivered by the hydraulic energy source, depending on the torques present.

A second valve arrangement 13 is also connected downstream from hydraulic energy source 7. Second valve arrangement 13 is connected to conical disks indicated by reference numeral 15, and serves to adjust the position of the conical disks 15, i.e. to set the transmission ratio of belt-driven conical-pulley transmission 3.

Also connected downstream from hydraulic energy source 7 is a third valve arrangement 17, which is connected to actuate a forward clutch 19 and a reverse clutch 21.

A hydraulic parking lock-release system 23 is also connected down-stream from hydraulic energy source 7. The parking lock-release system 23 of hydraulic system 1 is connected to a mechanical parking lock 25 indicated by reference numeral 25. The assignment can be effected by means of suitable mechanical aids, for example a lever. By means of the parking lock-release system 23, the mechanical parking lock 25 of motor vehicle 5 can be engaged, i.e. established, and released again.

Hydraulic energy source 7 also serves to supply a fourth valve arrangement 27. Fourth valve arrangement 27 serves to provide a cooling oil flow volume that is likewise provided by means of hydraulic energy source 7. To that end, fourth valve arrangement 27 is connected to a cooling circuit indicated by reference numeral 29, in particular to the cooler return 31, an active Hytronic cooling system 33, a jet pump 35 and a centrifugal oil cover 37.

Hydraulic energy source 7 is connected downstream through a branching 39 to a pilot pressure regulating valve 41. Pilot pressure regulating valve 41 regulates a pilot pressure 43 downstream, for example of around 5 bar, while the hydraulic energy source 7 provides a higher system pressure 45. The pilot pressure serves in a known way by means of suitable proportional valves, for example electrically actuatable proportional valves, to control the circuit components of hydraulic system 1. To adjust and distribute the hydraulic energy supplied by hydraulic energy source 7, a fifth valve arrangement 47 is provided.

To set or regulate the system pressure 45 ahead of torque sensor 11, the latter includes pressure regulating valves (not shown). First valve arrangement 9 includes a system pressure valve 49 connected ahead of torque sensor 11. System pressure valve 49 is connected downstream from fifth valve arrangement 47, and allows an appropriate flow volume for torque sensor 11 to pass, while the system pressure 45 upstream can be adjusted to a minimum system pressure, for example 6 bar. To set the adjusting pressure through short-term additional elevation of the system pressure 45, system pressure valve 49 is additionally connected upstream to second valve arrangement 13 through an OR element 63.

Second valve arrangement 13 includes a seventh valve 51 with a seventh control piston 53, connected downstream from hydraulic energy source 7. Seventh control piston 53 is connected downstream to an eighth valve 55 for actuation. The eighth valve 55 can be a control valve, for example an electrically actuatable proportional valve. Seventh valve 51 includes a first port 57 and a second port 59, which are each connected to corresponding adjusting elements of the conical disks 15. By means of the seventh control piston 53 of the seventh valve 51, hydraulic energy source 7 can optionally be connected continuously, i.e., with transfer flow, to first port 57 or second port 59. The particular port that is not connected to the hydraulic energy source 7 can be connected accordingly to a tank 61. In a middle position, both ports 57 and 59 can be disconnected from the hydraulic energy source 7 and switched to the tank 61. Thus a desired pressure ratio can be set in ports 57 and 59 by means of the seventh valve 51 of second valve arrangement 13 to adjust the conical disks 15. In addition, ports 57 and 59 are connected to system pressure valve 49 through the OR element 63 of the latter. Through that assignment, the minimum system pressure adjusted by means of system pressure valve 49 can be adapted by a desired amount to the seventh valve 51, i.e., raised, for example, by means of adjusting motions made by means of the latter.

Fourth valve arrangement 27 includes a cooling oil regulating valve 67 that is actuated by means of a fourth valve 65. Cooling oil regulating valve 67 is connected downstream from the fifth valve arrangement 47, and is supplied thereby with hydraulic energy by means of hydraulic energy source 7. In addition, fourth valve arrangement 27 includes a return valve 69, which is connected upstream directly to hydraulic energy source 7 or to a pump injector 70 of hydraulic energy source 7. Return valve 69 is connected downstream with a through connection to centrifugal oil cover 37 through a port of return valve 69, and as the volume flows rise it conveys a partial flow directly into the pump injector 70. Cooling oil regulating valve 67 serves to maintain and adjust a desired volume flow of cooling oil to the component 35 that is to be cooled.

The third valve arrangement 17 includes a first valve 71 with a first control piston 73. To actuate the first control piston 73, the latter is connected down-stream to a third valve 75, for example a control valve, for example an electrically actuatable proportional valve. The first control piston 73 of the first valve 71 can assume essentially three selector positions to actuate the forward clutch 19 and reverse clutch 21. In a first selector position, which is shown in FIG. 1, in which the reverse clutch 21 is pressurized, a first port 77 of the first valve 71 is connected to the hydraulic energy source 7 by means of first control piston 73, the assignment to the hydraulic energy source 7 being accomplished through a fifth valve 79. Fifth valve 79 is actuatable by means of a sixth valve 81, for example a control valve, for example an electrically actuatable proportional valve, and serves to provide or control and/or regulate a pressure necessary to engage the clutches 19 and 21 which are optionally connected downstream. If a torque to be transmitted is present, the pressure can be up to 20 bar for example. Advantageously, the fifth valve 79 can be used in addition, for example in the event of a problem, preferably in the case of an electric power failure, to switch the downstream first valve 71 to zero pressure, i.e. to separate the hydraulic energy source 7 from the first valve 71. Preferably, to that end the inlet of the first valve 71 can be switched to the tank 61.

In a second selector position, which corresponds to a displacement of the first control piston 73 of first valve 71 to the right, seen in the orientation in FIG. 1, the connection to the fifth valve 79, connected upstream, can be interrupted. At the same time, the first port 77 can be switched to the tank 61 by means of the first control piston 73 of first valve 71, so that the reverse clutch is depressurized. In addition, in that selector position the forward clutch 19 can also be switched to the tank 61 via a second port 83 of first valve 71.

In a third selector position, which corresponds to a further displacement of first control piston 73 to the right, seen in the orientation in FIG. 1, the second port 83 can be connected to the fifth valve 79 and the first port 77 to the tank 61. In that third selector position, which corresponds to an engaged forward gear of the motor vehicle 5, the forward clutch 19 is thus under pressure and the reverse clutch 21 is switched to zero pressure.

The parking lock-release system 23 includes a bipartite parking lock cylinder 85. Parking lock cylinder 85 can be biased toward the left, seen in the orientation in FIG. 1, by means of a return spring of the parking lock 25, not shown in further detail. Parking lock cylinder 85 can be moved to the right against that pre-tensioning, seen in the orientation in FIG. 1, to release the parking lock 25. To apply the appropriate hydraulic force, one end face 87 of parking lock cylinder 85 is connected downstream from a second valve 89 of the parking lock-release system 23. To increase the system pressure 45 during the release of the parking lock 25, it is conceivable to simultaneously operate the seventh valve 51 of the second valve arrangement 13 in any desired adjusting direction, whereby the system pressure 45 is increased through the downstream-connected OR element and the system pressure valve 49, for example to up to 50 bar.

The second valve 89 of the parking lock-release system 23 is connected downstream from hydraulic energy source 7, while the end face 87 of parking lock cylinder 85 is directly connected to the system pressure 45 of hydraulic energy source 7 by means of a second control piston 91 of second valve 89. The actuation of the second control piston 91 can be accomplished by means of the fourth valve 65 of the fourth valve arrangement 27, while the second control piston 91 is connected down-stream to the fourth valve 65. The cooling oil regulating valve 67 and the second valve 89 are thus equally actuated by the fourth valve 65, while for example the parking lock 25 can be released while the cooling oil flow volume is simultaneously turned on, and vice versa. It is also conceivable, however, to design the control surfaces and/or directions of action of the valves 67 and 89 differently, for example in such a way that the parking lock 25 is first released, and upon a further pressure increase of the fourth valve 65 the slide of the cooling oil regulating valve 67 is also operated to actuate the cooling. With that design it is thus possible to release the parking lock 25 without simultaneously having to actuate the cooling.

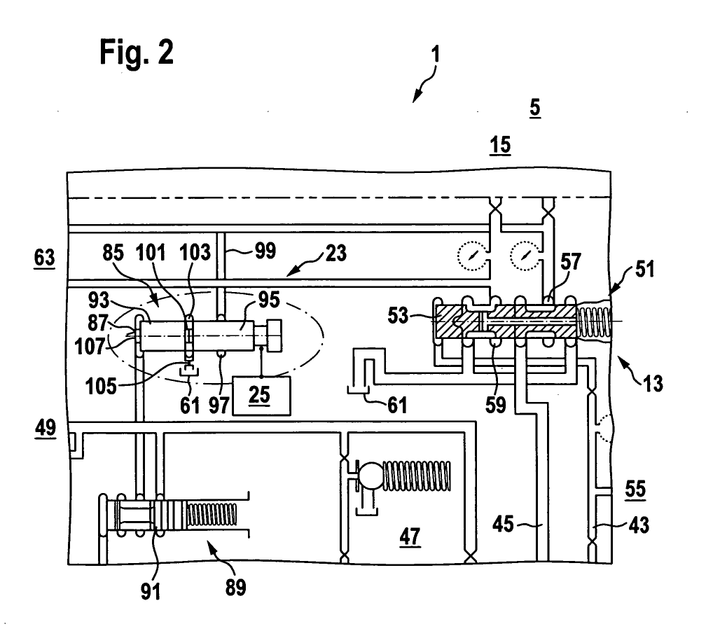

FIG. 2 shows a detail of the hydraulic circuit diagram of hydraulic system 1 shown in FIG. 1. The bipartite parking lock cylinder 85 with a first sub-cylinder 93 and a second sub-cylinder 95 can be recognized. Second sub-cylinder 95 is connected to mechanical parking lock 25 by means of a suitable mechanism.

Second sub-cylinder 95 is connected upstream through a port 97 and a branching 99 to a first port 57 of seventh valve 51. Seventh valve 51 is hydraulically actuatable by means of eighth valve 55, a position of seventh valve 51 being shown in FIG. 2 that corresponds to a de-energized state of eighth valve 55. It can be seen that in that state first port 57 of seventh valve 51 is connected to the system pressure 45 by means of a control edge of seventh control piston 53. Hence it is possible, in the event of an electric power failure in a control unit (not shown in further detail) for central activation of hydraulic system 1, to apply system pressure 45 to port 97 of parking lock cylinder 85.

First sub-cylinder 93 of parking lock cylinder 85 includes the end face 87, which is pressurizable by means of second control piston 91 of second valve 89. It is obvious that end face 87 of first sub-cylinder 93 is pressurizable to disengage parking lock 25; as that is done, first sub-cylinder 93 and second sub-cylinder 95 move uniformly to the right seen in the orientation of FIG. 2. Advantageously, to that end first sub-cylinder 93 and second sub-cylinder 95 are positioned side-by-side and are touching each other in a touch contact at a contact point 101. In the area of contact point 101, with parking lock 25 engaged, as shown in FIG. 2, there is a fourth port 103 of parking lock cylinder 85, which is connected upstream through an orifice plate 105 to tank 61.

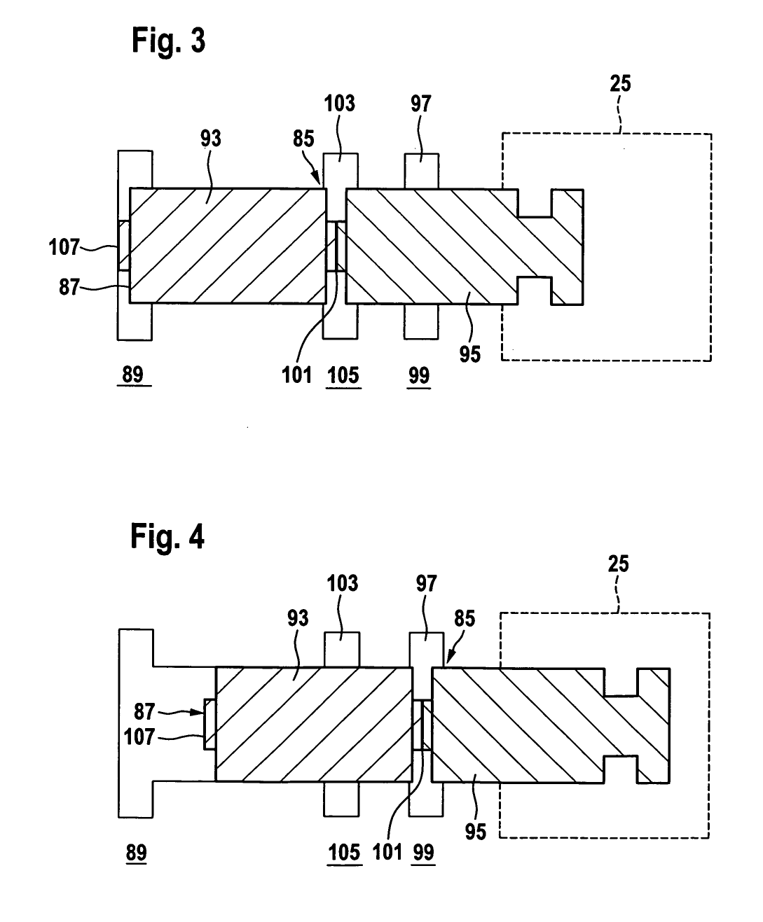

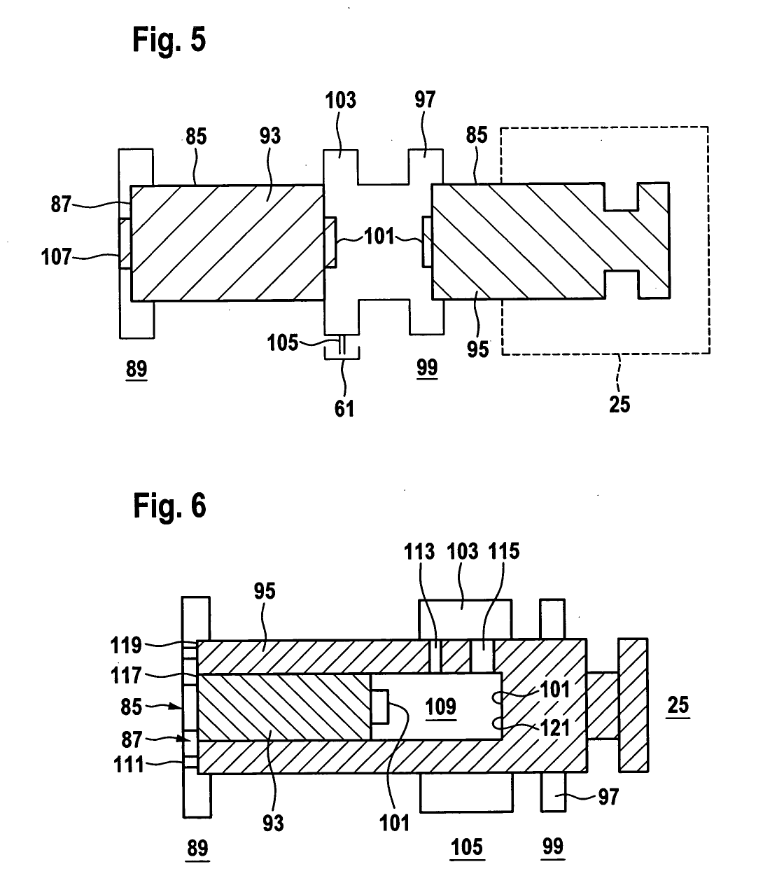

The function of parking lock cylinder 85 with first sub-cylinder 93 and second sub-cylinder 95 is explained in greater detail on the basis of FIGS. 3 through 5. Here FIG. 3 shows parking lock cylinder 85 with the transmission control turned on and parking lock 25 engaged. Parking lock 25 is symbolized in FIGS. 3 through 5 by a dashed rectangle. FIG. 4 shows parking lock cylinder 85 with the parking lock inactive and the transmission control turned on. FIG. 5 shows parking lock 85 with the transmission control turned off, as is the case for example with an electric power failure and/or a reset, and with the parking lock not engaged, the parking lock being held open by means of self-retention or a self-retaining function of parking lock cylinder 85.

As can be seen in FIG. 3, with the parking lock engaged and the end face 87 of first sub-cylinder 93 not under pressure, first sub-cylinder 93 and second sub-cylinder 95 are in a position to the left, seen in the orientation of FIGS. 3 through 5. In that case first sub-cylinder 93 and second sub-cylinder 95 are pressed to the left by a return spring, belonging for example to the mechanical parking lock 25, until first sub-cylinder 93 hits a stop 107 of parking lock cylinder 85.

The contact points 101 of the first and second sub-cylinders 93 and 95 are raised and centered, so that a surrounding intermediate space between corresponding control flanks of first and second sub-cylinders 93 and 95 results, which is connected to the fourth port 103 of parking lock cylinder 85. As shown in FIG. 3, that is the case with parking lock 25 actuated (left position). In FIG. 4 it can be seen that with parking lock 25 not engaged, the contact point 101 or the intermediate space surrounding first and second sub-cylinders 93 and 95 is connected to the third port 97 of parking lock cylinder 85, while both the first and the second sub-cylinder 95 are connected upstream through the branching to seventh valve 51. Advantageously in that selector position, as shown in FIG. 4, the pressure on the end face 87 is always higher than that connected via the seventh valve 31, so that it is guaranteed that with the parking lock 25 not engaged while the transmission control is turned on, as shown in FIG. 4, the first and second sub-cylinders 93 and 95 are touching at the contact point 101 and together move to the right.

In the event of an electric power failure of the transmission control, the end face 87 of first sub-cylinder 93 is switched to the tank 61 by means of the fourth valve, which is then de-energized, and the second valve 89 which is connected down-stream from it. That causes the first sub-cylinder 93, to move to the left to the stop 107, seen in the orientation of FIG. 5, while releasing the fourth port 103 in the direction of the orifice plate 105 and the tank 61. Advantageously, when a short-term power outage occurs the second sub-cylinder 95, realizing a self-retention of the parking lock cylinder 85, remains in the position shown in FIG. 4, i.e. shifted to the right, which is synonymous with a non-actuated parking lock 25. In the event of a power outage of the transmission control, the eighth valve 55 also shifts the control piston 53 of the seventh valve 51 to the tank 61, while the latter moves completely to the left, seen in the orientation of FIGS. 1 and 2, whereupon first port 57 is subjected to the system pressure 45. The system pressure 45 is introduced through branching 99 and third port 97 into the now enlarged intermediate space between the first and second sub-cylinders 93 and 95. Because of the volume transported by the hydraulic energy source 7, a back pressure results at the orifice plate 105; it is present in the intermediate space between the first and second sub-cylinders 93 and 95 and presses these apart, so that the first sub-cylinder 93 hits the stop 107 and the second sub-cylinder 95 remains in the position shown in FIGS. 4 and 5, which corresponds to a non-engaged parking lock 25. The intermediate space is connected to both ports 97 and 103 in that case.

In the event that following the electric power failure shown in FIG. 5 the hydraulic energy source 7 also no longer supplies energy, for example if a corresponding combustion engine of motor vehicle 5 is subsequently shut off, the pressure in the intermediate space of the first and second sub-cylinders 93 and 95 via the orifice plate 105 drops off rapidly toward the tank 61, so that the parking lock 25 engages automatically; that is, motor vehicle 5 is secured against rolling away.

FIGS. 6, 7, and 8 show another exemplary embodiment of the bipartite parking lock cylinder 85, where first sub-cylinder 93 is positioned movably in a bore 109 of second sub-cylinder 95. First sub-cylinder 93 is constructed essentially the same as in the preceding figures, but differs in that it is positioned in bore 109 of second sub-cylinder 95, so that it includes a smaller diameter than second sub-cylinder 95.

FIG. 6 shows first sub-cylinder 93 and second sub-cylinder 95 of parking lock cylinder 85 in a position that corresponds to the engaged parking lock 25. Here first sub-cylinder 93 makes contact with its stop 107, so that it is moved completely to the left, seen in the orientation of FIG. 6. That variant differs in that second sub-cylinder 95 also includes a stop 111, which also makes contact in such a way that it is moved as far as possible to the left, seen in the orientation of FIG. 6. That results in a free space within the bore 109 of second sub-cylinder 95, which free space is connected through a first perforation 133 and a second perforation 115 of second sub-cylinder 95 to fourth port 103, i.e., through orifice plate 105 to tank 61.

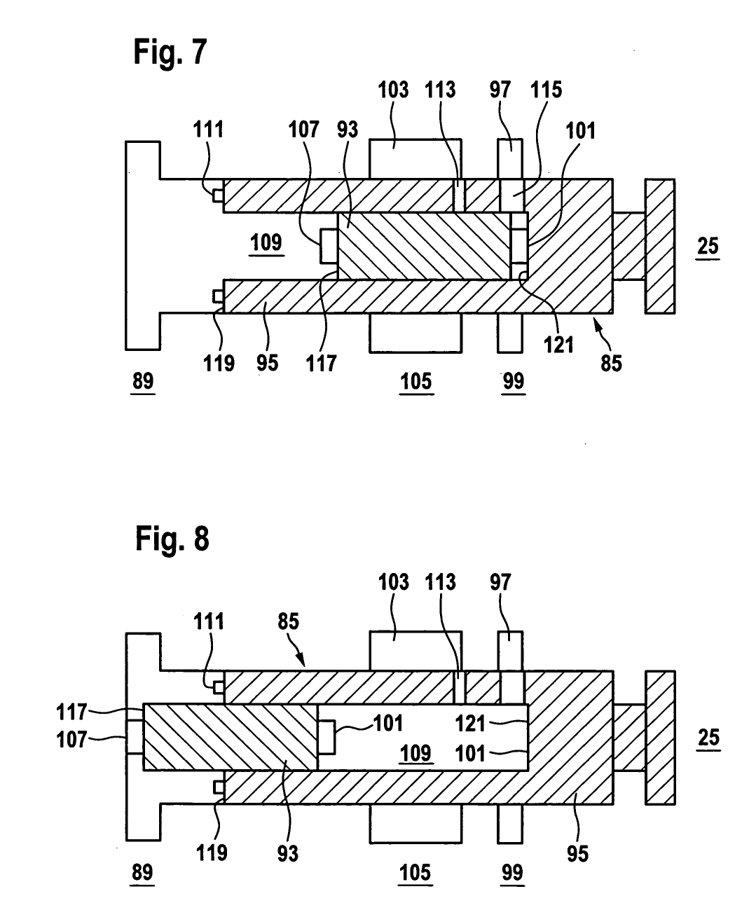

As a further difference, the sub-cylinders 93 and 95 of parking lock cylinder 85 are connected in parallel, i.e., they are similarly connected upstream to second valve 89. At the same time, end face 87 is divided into a first sub-surface 117 of first sub-cylinder 93 and a second sub-surface 119 of second sub-cylinder 95 of parking lock cylinder 85. When second valve 89 is connected, i.e. when parking lock 25 is not engaged, sub-surfaces 117 and 119 are subjected to the system pressure, so that both sub-cylinders 93 and 95 move completely to the right, seen in the orientation of FIG. 7, until the parking lock can no longer be moved any further. At the same time, first sub-cylinder 93 also moves completely to the right inside of bore 109, until sub-cylinders 93 and 95 are in touch contact at contact point 101. As that occurs, the free space between sub-cylinders 93 and 95 in bore 109 is reduced to a minimum; that free space is connected via second perforation 115 of second sub-cylinder 95 to the third port 97, i.e., upstream to seventh valve 51. Contact point 101 or first and/or second sub-cylinders 93, 95 can have a corresponding elevation, so that a sufficiently large free space remains in bore 109 so that second perforation 115 remains securely open even when parking lock 25 is not engaged. As can be seen in FIG. 7, first sub-cylinder 93 blocks off the first perforation 113 when parking lock 95 is engaged, i.e., when in the position shifted completely to the right in bore 109. Even when second sub-cylinder 95 is shifted completely to the right, first perforation 113 is connected to the fourth port 103, i.e., through orifice plate 105 to tank 61. To that end, fourth port 103 is designed considerably wider than third port 97.

In the representation in accordance with FIG. 8, which like the picture in accordance with FIG. 5 corresponds to a de-energized state of fourth valve 65 and of eighth valve 55, first sub-cylinder 93 is moved completely to the left, so that it makes contact at the left side with stop 107, and second sub-cylinder 95 is moved completely to the right, corresponding to the motion possibilities of the mechanism of parking lock 25. At the same time, second sub-cylinder 95 is in a self-retention position, while the intermediate space between the first and second sub-cylinders 93 and 95 inside bore 109 of second sub-cylinder 95 is maximally enlarged and is connected through perforations 113 and 115 to both ports 97 and 103. In that case the fourth port 103 is of such wide design that the first perforation 113 is connected through orifice plate 105 to tank 61 in every position (FIG. 6 and FIGS. 7, 8). In the representation in accordance with FIG. 8, the intermediate space or bore 109 of second sub-cylinder 95 is subjected to the system pressure 45 through seventh valve 51. That system pressure 45 is present on an inner end face 121 of bore 109, which is executed as a blind hole. The inner end face 121, together with seventh control piston 53 of seventh valve 51, which switches the system pressure when the electric power fails, realizes the self-retention of second sub-cylinder 95, while the system pressure 45 acting on the inner end face 121 is sufficient to hold parking lock 25 in its non-engaged position, at least long enough so that hydraulic energy source 7 builds up the system pressure 45. In the event that hydraulic energy source 7 is also shut down, the pressure built up in bore 109 against orifice plate 105 can dissipate through orifice plate 105 in the direction of tank 61, while second sub-cylinder 95 moves to the left, seen in the orientation of FIG. 8, driven for example by a corresponding return spring of parking lock 25. That process causes the intermediate space in bore 109 to shrink again until the position shown in FIG. 6 develops, whereupon parking lock 25 is automatically engaged, i.e., motor vehicle 5 is secured against rolling away.

Parking lock cylinder 85 of hydraulic system 1 is actuated by way of the upstream second control piston 91, which connects the currently present system pressure 45 through to parking lock cylinder 85. Second control piston 91 is controlled in that case by fourth valve 65, and accordingly is dependent on electrical current levels that are provided by a transmission control (not shown in greater detail). Parking lock cylinder 85 includes only one control connection. In the event of an electric power failure, second control piston 91 moves to its initial state and switches the control connection of parking lock cylinder 85 in the direction of tank 61.

In order to prevent an associated engaging of parking lock 25, parking lock cylinder 85 is of bipartite design, with first sub-cylinder 93 and second sub-cylinder 95. The basic circuitry of hydraulic system 1 is in principle not affected thereby, while first sub-cylinder 93 includes the pressurizable end face 87 (FIGS. 3 through 5), or end face 87 is divided into the two sub-surfaces 117 and 119 (FIGS. 5 through 8). When both sub-cylinders 93 and 95 have reached a right-side end position, the adjusting pressure for the conical disks 15 provided via the seventh valve 51 is brought to bear in the intermediate space between first and second sub-cylinders 93 and 95 by means of third port 97 and by means of branching 99. Since the pressure on end face 87 of first sub-cylinder 93 is always greater than the adjusting pressure, in normal operation the two sub-cylinders 93 and 95 remain in touch contact at contact point 101.

If the electric power supply of the transmission control (not shown in greater detail) is now lost, the control pressure present on the end face 87 of parking lock cylinder 85 or of first sub-cylinder 93 drops to 0 bar, but at the same time the maximum possible control pressure of the conical disks 15 is present in the intermediate space between first and second sub-cylinders 93 and 95, since the eighth valve 55 for controlling the seventh valve 51 is also de-energized. That pressure ensures that the second sub-cylinder 95 of parking lock cylinder 85 remains in the switched position, i.e., with the parking lock not engaged, and bridges over the electric power outage, for example at least 500 ms. Accordingly, during the electric power outage first and second sub-cylinders 93 and 95 are moved apart and an oil-filled intermediate space develops. Normally that would not result in any problem, since under normal conditions the power supply can be switched on again after 0.5 seconds, and sub-cylinders 93 and 95 can be moved toward each other on the basis of the pressure differential between the two control connections. On the other hand, if an internal combustion engine of motor vehicle 5 is shut down in the period of the power outage, a significant delay could occur in engaging the parking lock 25, since the oil volume between the two sub-cylinders 93 and 95 would have to be removed through gap leakage in order to move second sub-cylinder 95 into its starting position. Advantageously, that can be prevented by fourth port 103, which ensures that in that case the oil can drain away in the direction of tank 61. The inlet to the tank can advantageously be provided with orifice plate 105, so that in the event of electric power failure the control pressure can build up in the intermediate space at all.

As an alternative, it is possible to provide an inner piston corresponding to the representations in FIGS. 6 and 7 instead of a tandem piston, where first sub-cylinder 93 is designed as an inner piston of second sub-cylinder 95. In the non-switched position, as shown in FIG. 6, parking lock 25 is engaged, where both inner sub-cylinder 93 and outer second sub-cylinder 95 are against their left stops 107 and 111. Second sub-cylinder 95 blocks off third port 97, so that the adjusting pressure of the first pulley of conical disks 15 does not act on parking lock cylinder 85.

If parking lock cylinder 85 is actuated by means of second valve 89 (see FIG. 7), both inner first sub-cylinder 93 and outer second sub-cylinder 95 move to the right. In that position the adjusting pressure or the system pressure 45 is finally conducted into the inner bore 109. Since the system pressure 45, which is present on the left side on sub-surfaces 117 and 119 of end face 87, is always greater than the adjusting pressure which it controls, because of the control function of the seventh valve 51, in that situation inner sub-cylinder remains against its right stop, so that it touches second sub-cylinder 95 at contact point 101.

If the electric power now fails and second valve 89 opens the left control connection, which is connected to end face 87, in the direction of tank 61, inner first sub-cylinder 93 does move to the right; however the adjusting pressure present at third port 97, which acts on the inner end face 121 of second sub-cylinder 95, ensures that parking lock 25 is kept disengaged (see FIG. 8).

Advantageously, for example in the case of a reset of the transmission control (not shown in greater detail) and of an electric power outage associated therewith, parking lock cylinder 85 can be brought to self-retention by means of the dual piston principle employed. In that case, first sub-cylinder 93 is pressurized by means of the upstream second valve 89 in proportion to the present current level of fourth valve 65. Parking lock cylinder 85 thereby assumes the normal function. With the electric power outage, on the other hand, the adjusting pressure for the pulley 1 of conical disks 15 acts on second sub-cylinder 95. Since that adjusting pressure assumes its maximum value to actuate seventh valve 51, because eighth valve 55 is likewise de-energized, parking lock cylinder 85 or second sub-cylinder 95 of parking lock cylinder 85 is held in a position that corresponds to a non-engaged parking lock 25. Advantageously, that self-retention can be held for at least 500 ms, during which an engagement of parking lock 25 can be prevented reliably.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A hydraulic system for controlling a belt-driven conical-pulley transmission of a motor vehicle having a variably adjustable transmission ratio, said hydraulic system comprising:
an electrical actuation system for overall control of the hydraulic system,
a hydraulic parking lock-release system to control a parking lock,
wherein the parking lock includes self-retention in the event of a power failure of the electrical actuation system.

2. A hydraulic system in accordance with claim 1, wherein the hydraulic parking lock-release system includes a second valve for hydraulic actuation of a parking lock cylinder positioned downstream from the second valve for mechanical actuation of the parking lock.

3. A hydraulic system in accordance with claim 2, wherein the electrical actuation system includes a fourth valve positioned upstream from the in particular second valve to actuate a second control piston of the second valve.

4. A hydraulic system in accordance with claim 2, wherein the parking lock cylinder includes a first sub-cylinder and a second sub-cylinder.

5. A hydraulic system in accordance with claim 4, wherein to realize the self-retention when the parking lock is disengaged, the second sub-cylinder is connected upstream to a seventh valve of a second valve arrangement for controlling the transmission ratio of the belt-driven conical-pulley transmission.

6. A hydraulic system in accordance with claim 5, wherein the second sub-cylinder is connected to a first port of the seventh valve.

7. A hydraulic system in accordance with claim 6, wherein the electric actuation system includes an eighth valve to actuate the seventh valve and which switches the first port of the seventh valve to a system pressure of the hydraulic system during the power failure.

8. A hydraulic system in accordance with claim 4, wherein the second valve actuates the first sub-cylinder downstream.

9. A hydraulic system in accordance with claim 4, wherein the first and the second sub-cylinders are positioned one after the other.

10. A hydraulic system in accordance with claim 4, wherein the second valve actuates the first and second sub-cylinders downstream.

11. A hydraulic system in accordance with claim 10, wherein the first sub-cylinder is positioned in a bore of the second sub-cylinder.

12. A hydraulic system in accordance with claim 4, wherein the second sub-cylinder is connected during the power failure to the seventh valve, and through an orifice plate to a tank.

13. A hydraulic system in accordance with claim 12, wherein during the electric power failure and with the parking lock engaged the first sub-cylinder assigns the second sub-cylinder to the tank, and with the parking lock engaged by means of the electrical actuation system it blocks the assignment of the second sub-cylinder to the tank.

14. A belt-driven conical-pulley transmission having a hydraulic system in accordance with claim 1.

15. A motor vehicle having a belt-driven conical-pulley transmission in accordance with claim 14.
